(19) United States
(12) Patent Application Publication
(10) Pub. No.: US 2017/0072913 A1
(43) Pub. Date: Mar. 16, 2017

(54) METHOD AND DEVICE FOR DE-ICING A VEHICLE WINDOW

(71) Applicant: Valeo Systèmes d'Essuyage, Le Mesnil Saint Denis (FR)

(72) Inventors: Denis Thebault, Lempdes (FR); Grégory Kolanowski, Siaugues-Saint-Marie (FR)

(73) Assignee: Valeo Systèmes d'Essuyage, Le Mesnil Saint Denis (FR)

(21) Appl. No.: 15/266,387

(22) Filed: Sep. 15, 2016

(30) Foreign Application Priority Data
Sep. 15, 2015 (FR) 1558608

(51) Int. Cl. B60S 1/48; B60S 1/28; B60S 1/08; B08B 1/00; B08B 3/02

(52) U.S. Cl. CPC B60S 1/485; B08B 1/001; B08B 3/02; B60S 1/08; B60S 1/0866; B60S 1/28

(57) ABSTRACT

Method for de-icing a vehicle window (10), said vehicle being equipped with a de-icing device notably comprising at least one tank containing a de-icing liquid, at least one wiper blade, openings through which said liquid is sprayed onto said window, and an outside temperature sensor, characterized in that it comprises a step consisting in ejecting the liquid via said openings and adapting the quantity Q of liquid sprayed as a function of the outside temperature so that when said outside temperature is equal to T1 a quantity of liquid is ejected and when the outside temperature is equal to T2, with T2<T1, an identical or different quantity of liquid is ejected.

### TECHNICAL FIELD

The technical sector of the present invention is that of methods for de-icing a window of a vehicle, notably a motor vehicle, using a device for deicing said window.

### PRIOR ART

Motor vehicles are commonly equipped with window washing and wiping systems to wash and wipe the windows and thus to prevent the driver's view of their environment from being disturbed. An installation of this kind generally comprises two wiper blades that wipe the outside surface of the window, such as the windscreen, so as to evacuate the water present on that surface. Nozzles are positioned at the level of the bonnet of the vehicle or, in a more recent version, on the blades, and are fed with windscreen washing liquid via a pump and a tube system connected to a windscreen washing liquid tank.

Some motor vehicles are equipped with de-icing systems. A de-icing system generally comprises a standard washing and wiping system of the aforementioned type and additionally comprises a de-icing liquid tank and even an additional pump. With the aim of de-icing a window in cold weather, the nozzles are fed with de-icing liquid via the pump and the tube system connected to the de-icing liquid tank.

The applicant has already proposed de-icing systems and devices, notably described in the document FR-A1-2 789 034.

It is known that the de-icing liquid has a viscosity that increases as the temperature decreases. Accordingly, the lower the outside temperature the more viscous the de-icing liquid. The viscosity of this liquid at −5° C. may for example be half that of the liquid at −20° C. This viscosity difference has a direct impact on the flow rate of liquid sprayed by the nozzles.

It has also been found that the performance of a pump is influenced by the outside temperature, and decreases in cold weather. These two factors have a significant influence on the quantities of de-icing liquid sprayed in cold weather. It is therefore necessary to find a solution to guarantee that a minimum quantity of de-icing liquid is sprayed, whatever the temperature outside the vehicle, and that this solution does not lead to overconsumption of de-icing liquid, which is relatively costly.

The invention provides a solution to this requirement that is simple, effective and economical.

### STATEMENT OF THE INVENTION

To this end the invention proposes a method for de-icing a vehicle window, said vehicle being equipped with a de-icing device comprising:
a. at least one tank containing a de-icing liquid,
b. a tube system connecting said at least one tank to openings through which said liquid is sprayed onto said window,
c. a pump intended to cause said liquid to circulate in the tube system until it is ejected via said openings, and
d. at least one wiper blade able to move on said widow between a low position and a high position,
e. a motor for driving rotation of said at least one blade,
f. a sensor of the temperature T outside the vehicle, and
g. an electronic unit for controlling said motor and actuating said pump, characterized in that it comprises a step 1) consisting in:
   ejecting the liquid via said openings and adapting the quantity Q of liquid sprayed as a function of said outside temperature, so that:
      when said outside temperature is equal to T1, a quantity Q1 of liquid is ejected via said openings, and
      when the outside temperature is equal to T2, with T2<T1, a quantity Q2 of liquid is ejected via said openings, with Q2>Q1,
   or ejecting the liquid via said openings and maintaining the quantity Q of liquid sprayed constant whatever said outside temperature, so that:
      when said outside temperature is equal to T1 and said liquid has a viscosity W1 , the quantity Q of liquid is ejected via said openings, and
when the outside temperature is equal to T2, with T2<T1, and said liquid has a viscosity W2, with W2>W1, the same quantity Q of liquid is ejected via said openings.

Thus, the invention proposes either to adapt the quantity of de-icing liquid sprayed as a function of the outside temperature or to maintain the quantity of liquid sprayed constant whatever the outside temperature. In the first instance, the quantity of liquid sprayed increases when the outside temperature is very low.

Regulating the quantity of liquid as a function of the outside temperature makes it possible to solve the aforementioned problem of overconsumption of liquid because the quantity of liquid sprayed is optimised to de-ice the window exposed to a given outside temperature.

Maintaining the quantity of liquid sprayed substantially constant whatever the outside temperature makes it possible to solve the aforementioned technical problem of the influence of the outside temperature on the viscosity of the liquid. Whatever the viscosity of the liquid, the quantity sprayed to de-ice the window is the same.

The method in accordance with the invention may comprise one or more of the following features, steps or sub-steps, separately from one another or in combination with one another.
2) moving said at least one blade from said low position to said high position via a plurality of successive angular movements,
   said steps 1) and 2) being notably performable simultaneously;
said motor being configured so that the rotation speed V of said at least one blade and the quantity of liquid ejected by said pump are controlled by modulation of the pulse width and/or amplitude of their control signals, the step 2) is executed by a plurality of successive pulses of the control signal of said motor and the step 1) is executed by a plurality of successive pulses of the control signal of said pump;
the adaptation in the step 1) is executed by regulating the pulse width and/or amplitude of the control signal of said pump, so that:
   when said outside temperature is equal to T1, a pulse width Θ1 and/or the pulse amplitude LI1 of said signal is/are applied to said pump,
   when the outside temperature is equal to T2, the pulse width Θ2 and/or the pulse amplitude LI2 of said signal is/are applied to said pump, with Θ2>Θ1 and LI2>LI1;
the adaptation in the step 1) is executed by regulating the rotation speed V of said at least one blade, so that:
   when said outside temperature is equal to T1, a speed V1 is applied to said at least one blade,
   when the outside temperature is equal to T2, a speed V2 is applied to said at least one blade, with V2<V1;
T1 is between −5° C. and +5° C. inclusive, preferably between −2° C. and +2° C. inclusive, and is for example 0° C.;
T2 is between −10° C. and −30° C. inclusive, preferably between −15° C. and −25° C. inclusive, and is for example −20° C.;
Θ2=k.Θ1, with k a coefficient;
V1=k.V2, with k a coefficient;
k is between 1.5 and 3 inclusive, and is for example 2;
the steps 1) and 2) are executed when the vehicle is stopped, i.e. when the speed of the vehicle is zero;
the steps 1) and 2) are followed by step consisting in:
   3) moving said at least one blade from said high position to said low position, by means of a single angular movement, and
   4) ejecting the liquid via said openings during said movement and adapting the quantity Q of liquid sprayed as a function of said outside temperature, so that:
      when said outside temperature is equal to T1, a quantity Q1 of liquid is ejected via said openings during said movement,
      when the outside temperature is equal to T2, with T2<T1, a quantity Q2 of liquid is ejected via said openings during said movement, with Q2>Q1;
during the steps 3) and 4), said pump is controlled by a pulse of its control signal of predetermined width and amplitude;
the adaptation in the step 4) is executed by regulating the rotation speed V of said at least one blade, so that:
   when said outside temperature is equal to T1, a speed V1 is applied to said at least one blade,
   when the outside temperature is equal to T2, a speed V2 is applied to said at least one blade, with V2<V1.

The present invention also concerns a device for de-icing a vehicle window, comprising:
a. at least one tank (3) containing a de-icing liquid,
b. a tube system (5) connecting said at least one tank to openings (15) through which said liquid is sprayed onto said window (10),
c. a pump (22) intended to cause said liquid to circulate in the tube system (5) until it is ejected via said openings (15), and
d. at least one wiper blade (30) able to move on said window (10) between a low position (PB) and a high position (PH),
e. a rotary-drive motor (40) of said at least one blade,
f. a sensor of the temperature T outside the vehicle, and
g. an electronic unit for controlling said motor and actuating said pump, characterized in that said electronic unit is configured to execute the steps of the method according to any one of the preceding claims.

### DESCRIPTION OF THE FIGURES

Other features and advantages of the invention will become apparent on reading the following description of embodiments given by way of illustration and with reference to the appended figures. In those figures:

FIG. 1 is a diagrammatic view of a device for washing and de-icing a window, here of a motor vehicle;

FIGS. 2 and 3 are diagrammatic views showing a cycle of de-icing the window;

FIGS. 4a, 4b and 4c are graphs illustrating the various steps of one embodiment of the de-icing method in accordance with the invention;

FIGS. 5a and 5b are graphs illustrating the various steps of a variant embodiment of the de-icing method in accordance with the invention; and

FIGS. 6a-6b and 7a-7b are graphs illustrating other variant embodiments of the de-icing method in accordance with the invention.

### DETAILED DESCRIPTION

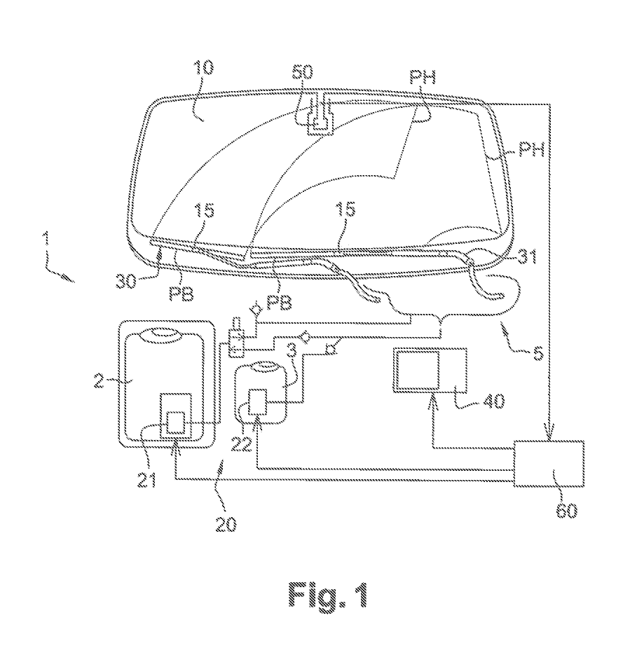

The de-icing method of the invention utilises a de-icing device 1 applied to a window, such as a motor vehicle windscreen 10, as shown in FIG. 1.

A device of this kind comprises a first tank 2 containing a washing liquid and a second tank 3 containing a de-icing liquid.

The washing device 1 also comprises a tube system 5 connecting the first tank 2 and the second tank 3 to openings 15 through which the washing liquid and/or the de-icing liquid is/are ejected onto the windscreen 10. It further comprises a pump system 20 intended to cause the washing liquid and/or the de-icing liquid to circulate in the tube system 5 until ejected via the openings 15.

Here the pump system 20 comprises two independent pumps 21, 22. A first pump 21 is associated with the first tank 2 and is intended to cause the washing liquid to circulate in the tube system 5 and a second pump 22 is associated with the second tank 3 and is intended to cause the de-icing liquid to circulate in the tube system 5.

The de-icing device 1 comprises at least one wiper blade 30 mounted on an arm 31 and able to move on the windscreen 10 between a low position PB and a high position PH, and vice versa. In the example represented, the device 1 comprises two wiper blades 30.

Here the aforementioned openings 15 are situated along the wiper blades 30. The openings 15 are disposed so as to spray the washing liquid and/or the de-icing liquid toward the top of the wiper blades 30, i.e. toward the top of the windscreen 10. The system could equally well comprise openings 15 situated on both sides of the wiper blades, the liquid then being sprayed either only in the direction of upward movement or only on the forward side of the blade. It is equally possible for the openings 15 situated on both sides of the wiper blades 30 to spray the liquid simultaneously.

The device 1 also comprises a motor 40 intended to drive the wiper blades 30 between their respective low position and their respective high position. The device 1 further comprises a sensor 50 of the temperature outside the vehicle. Here it is situated on an upper part of the windscreen, at the centre thereof, without this position being limiting on the invention. The sensor 50 may be directly exposed to the surrounding air outside the vehicle and is intended to measure the outside temperature, for example in a range of values from −50° C. to +50° C.

The de-icing device 1 further comprises an electronic circuit 60 for controlling the motor 40 driving the wiper blades 30 and activating the pump system 20, the pumps 21, 22 being capable of being controlled independently. In the remainder of the description of the invention the motor 40 chosen to drive the wiper blades and the second pump 22 chosen to feed de-icing liquid are a motor or pump of the dc stepper type, or of the reversible type, the rotation speed of the one and the output pressure or the quantity of liquid evacuated of the other, are controlled by modulation of the pulse width of their control signals. Any other device may be envisaged provided that this speed and/or this pressure/quantity can be modulated.

The unit 60 is also connected to the sensor 50 and receives the measured temperature in order to adapt at least one of the aforementioned parameters (speed and/or pressure/quantity) accordingly.

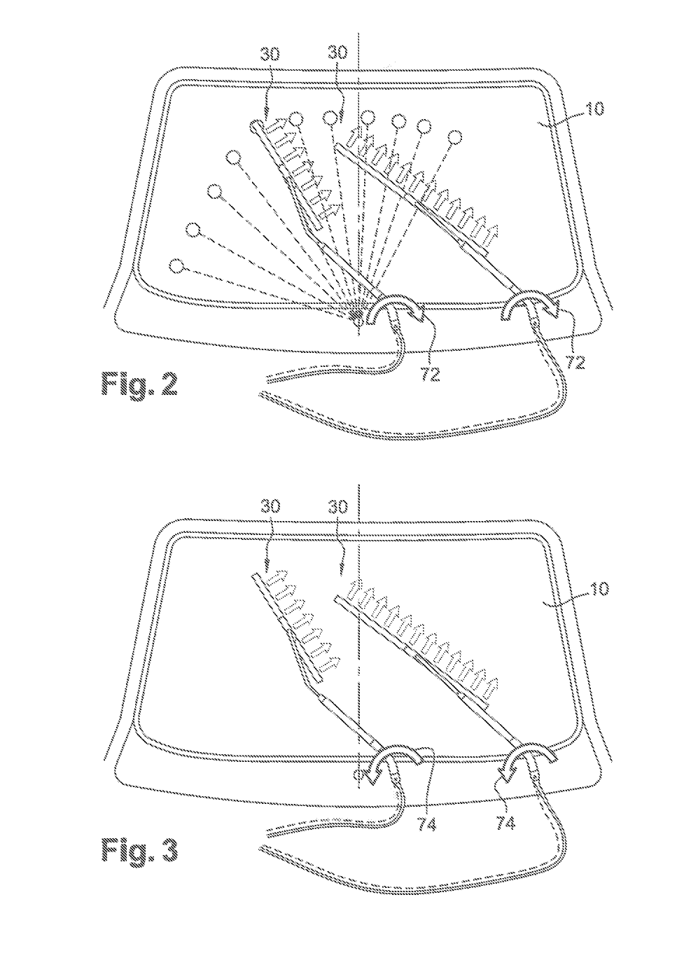

FIGS. 2 and 3 represent a cycle of de-icing the windscreen 10. This cycle comprises a rising movement of the blades 30, i.e. their movement from their low position to their high position (FIG. 2 and arrow 72), and a descent of the blades, i.e. their movement from their high position to their low position (FIG. 3 and arrows 74).

Each blade 30 rises in a succession of small elementary or angular movements, of which there are ten in the example represented. The departure and arrival angular positions for each of these movements are represented diagrammatically in dashed line in FIG. 2 for only one of the blades (that on the left in the drawing). The surface of the windscreen 10 wiped by each blade is therefore divided into a succession of angular sectors.

Each blade 30 descends in a single movement (FIG. 3). The departure and arrival angular positions for this movement therefore correspond to the high and low positions of each blade, respectively.

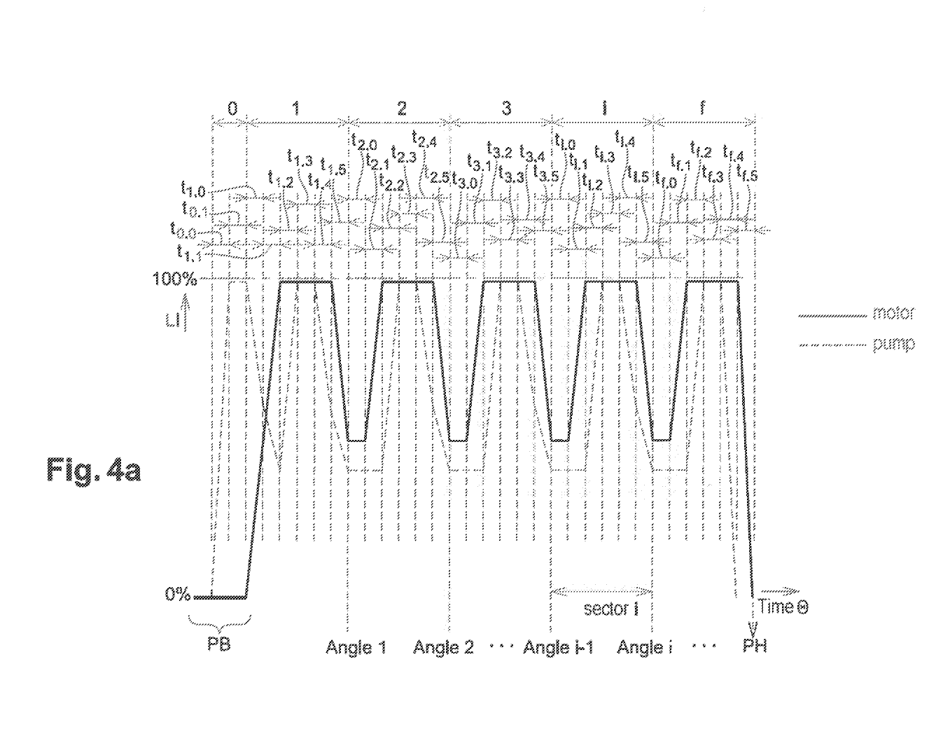

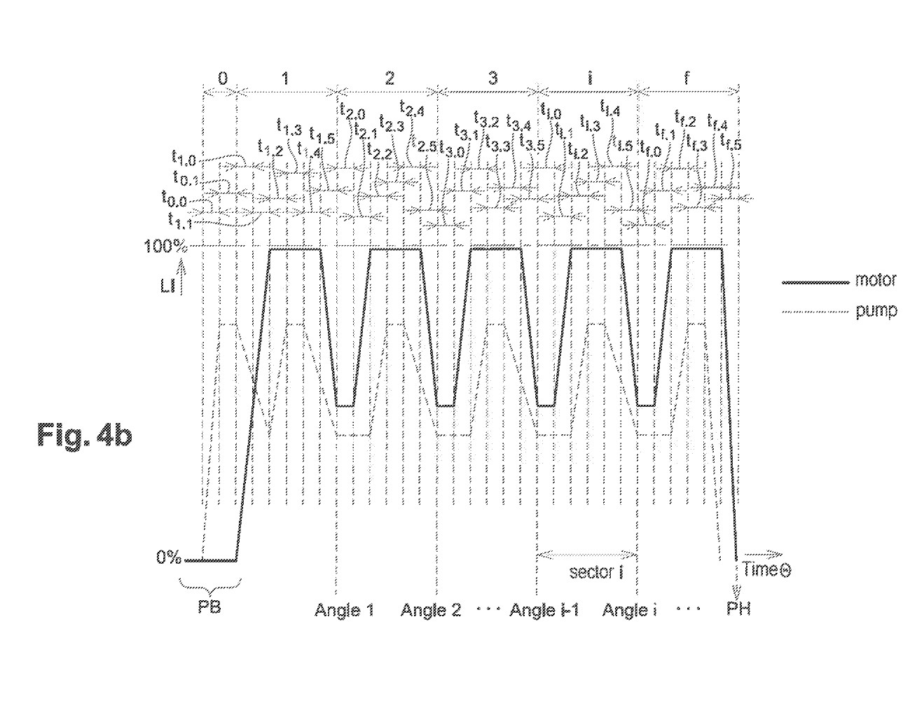

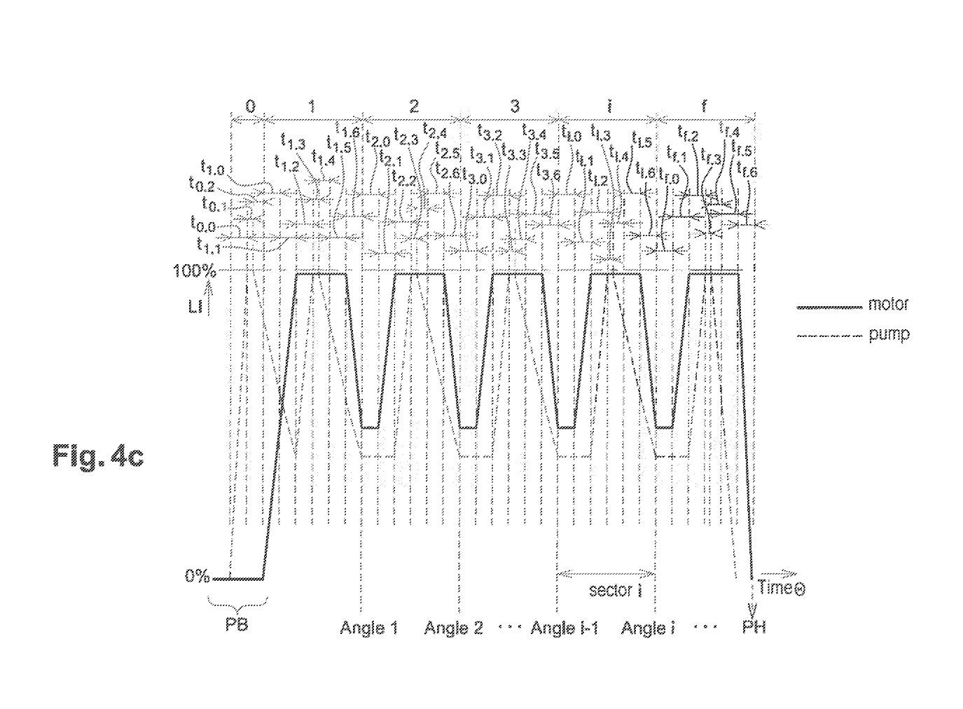

FIG. 4e represents a method for de-icing a window illustrated by a graph in which time or the pulse width Θ is represented on the abscissa axis and the amplitude (LI) of the control signals on the ordinate axis, namely the control signal of the motor 40 driving the blades 30 (continuous line) and the control signal of the pump 22 feeding the nozzles 15 with de-icing liquid (dashed line).

It is seen that the rotation of a blade between its low position PB and its high position PH (rising movement) is divided into a succession of angular sectors that correspond to the aforementioned angular sectors (of which there are five in the example shown), and therefore of pulses of the control signals.

The operation of the drive motor 40 and the de-icing pump 22 will be described with reference to a given elementary sector “i” that extends between an angle i−1 and an angle i measured from the low position PB. The drive motor 40 and the feed pump 22 are controlled identically in the other sectors, this control scheme being repeated over all of the angular amplitude of wiping by the blade 30, except for the first sector referenced 0 and the final sector referenced f, in which the control of these two units is as will be described later.

At the start of the elementary sector i, i.e. at the level of the angle i−1, the speed of the drive motor 40 and the quantity of liquid ejected by the feed pump 22 are reduced by a control signal the pulse amplitude (LI) of which is respectively 50% for the motor and 40% for the pump of their maximum value. These reduced values are maintained for a duration ti.0.

Then, at the end of the time ti.0, the pulse amplitude sent to control the drive motor 40 is progressively increased to 100%, over a width or duration (Θ) ti.1, which corresponds to the maximum speed of response to the command to vary the motor speed. This pulse amplitude is then maintained at 100% for a duration equal to the sum of the three durations ti,2, ti.3 and ti.4. Throughout this time, the rotation speed of the drive motor 40 is the maximum speed, i.e. equal to its nominal rotation value during use of the blades to wipe the windscreen, for example. Beyond this time ti.4, the pulse amplitude is returned to its value reduced by 50% for a duration ti.5.

In parallel with this, the pulse amplitude imparted to the control signal of the feed pump 22 remains at its value reduced by 40% for the first duration ti.1, extending the initial duration ti.0. It is then progressively increased to 100% over a duration ti.2 that corresponds to the maximum speed of response to the commands that control the pump. The pulse amplitude is then maintained at 100% for a duration equal to the duration ti.3. Throughout this time, the quantity of liquid ejected by the feed pump 22 is the maximum quantity, i.e. equal to its nominal pressure during use of the blades to wash the windscreen, for example (when the de-icing function is not used).

Beyond this time, and for a duration ti.4, which corresponds to the response time of the control unit of the pump, the pulse amplitude is initially brought to a first reduced value, equal to 60% of the maximum value, and then over a duration ti.5 to a further reduced value, equal to 40% of the maximum value of the pulse amplitude. At the end of this time ti.5, the pulse amplitudes of the drive motor 40 and the feed pump 22 are returned to the values that they had at the start of the sector i, and may follow a new cycle, over a sector i+1.

All these cycles, which are identical, are preceded by a starting cycle referenced ‘0’ and a completion cycle referenced “f”.

In the rest position of the blades, at the beginning of the starting cycle, the blades are immobile in their low position, the drive motor and the feed pump being stopped because the pulse amplitude transmitted to their control system is equal to zero. For a time t0.0, during which the drive motor 40 remains stopped, the pulse amplitude controlling the feed pump 22 is progressively increased to 100%, this duration t0.0 corresponding to the maximum rate of increasing the pulse amplitude between 0 and 100%. This pulse amplitude of 100% is maintained for a duration t0.1, the time that the de-icing liquid spreads onto the bottom part of the windscreen and melts the ice that has been able to accumulate there and immobilize the blades 15. At the end of this time t0.1, and for a duration equal to t1.0 and t1.1, the drive motor 40 is started by progressively increasing the pulse amplitude of its control signal from 0 to 100%. In parallel with this, the pulse amplitude of the feed pump 22 is reduced from 100% to 60%, then to 40%, during the two times t1.0 and t1.1, respectively, that correspond to the first two times of the first de-icing cycle, that cycle being implemented over the angular sector for which i=1. The connection between the starting cycle and the first cycle is effected by choosing appropriate durations t1.0 and t1.1. The duration t1.0 is such that the pulse amplitude of the motor reaches approximately 50% at the end of this time. As for the duration t.1, it is chosen so that, at the end of this time, the pulse amplitude of the drive motor 40 reaches 100% and at the same time that of the feed pump 22 reaches 40%.

Before initiating the completion cycle “f”, the pulse amplitude controlling the motor and the pulse amplitude controlling the feed pump 22 are both at 100% at the end of the time tf.3. Those amplitudes will then be reduced separately, and firstly the pulse amplitude of the control signal of the feed pump 22 will be reduced to zero and therefore lead to complete stopping of the feed pump at the end of a time tf.4. Likewise, the pulse amplitude of the drive motor 40 will be reduced to zero and therefore lead to complete stopping of this motor between the end of the time tf.4 and the end of the time tf.5.

This completes the de-icing cycle over one outward movement of the blade and the latter can than be returned to its low position PB by a single movement as mentioned above. The return sweep may be used to purge the tube system 5 of de-icing liquid by starting the washing pump 21. The liquid sprayed during this descent phase of the blade advantageously applies a protective film to the windscreen, which prevents the reappearance of ice thereon. Thereafter, as a function of the situation of the windscreen, a new de-icing cycle may be executed during the next rising movement of the blade.

The cycle of de-icing a windscreen therefore comprises, outside the starting and completion cycles:
The angular sector that is swept by each of the blades is divided into consecutive elementary sectors. The pulse amplitudes of the control signals correspond to the efficacy necessary to spread a given quantity of de-icing liquid over each elementary sector and its impregnation of the ice. The drive motor 40 is successively brought to its maximum speed, by increasing to 100% the pulse amplitude of its control signal, and then maintained at that value for a plurality of durations ti.2, ti.3 and ti.4. The duration ti.2 corresponds to the duration necessary to increase the pulse amplitude of the control signal of the feed pump 22 from its reduced value to its 100% value. The duration ti.3 corresponds to the time necessary for the required quantity of de-icing liquid to be delivered to the openings 15 of the blade. Finally, the duration ti.4 corresponds to the duration of slowing the pump which results from the reduction of the pulse amplitude of its control signal from 100% to 60%, a pulse amplitude of its control signal of 40% being reached at the end of the time ti.5. During the duration ti.4, de-icing liquid is still discharged abundantly by the feed pump and the rotation speed of the motor 40 driving the blades is maintained at its maximum value. Note that the drive motor 40 is still at its maximum speed when the feed pump 22 goes to its maximum output pressure to ensure proper distribution of the de-icing liquid over the elementary sector concerned. Moreover, the duration during which the feed pump 22 is at its maximum pressure is shorter than that at the maximum speed of the motor 40, this duration being preceded and followed by a period of maximum rotation of the drive motor. The sequence of these periods of maximum speed and output pressure ensures good distribution of the de-icing liquid with optimum efficacy for impregnating the ice and with the result of reducing the necessary quantity.
The pulse amplitude of the control signal of the drive motor 40 is then reduced to a reduced value (typically 50%, without this value being imperative) that corresponds to slower rotation of the blade. This reduced speed corresponds to a phase of spreading the de-icing liquid over the elementary sector concerned and impregnating the ice, to allow this liquid the time to act.
The pulse amplitudes of the drive motor 40 and the feed pump 22 are maintained for a while at their reduced values before starting a new de-icing cycle on the next elementary sector, with relaunching of the pulse amplitude of the drive motor and then that of the feed pump.
At the end of the de-icing cycle, when the blade reaches the vicinity of its high point PH, the cycle over the final elementary sector T simply consists in reducing the pulse amplitudes of the two control signals to zero, stopping the delivery of the de-icing liquid and halting the rotation of the drive motor.

FIG. 4a represents a de-icing cycle that is monitored by the electronic unit 60 of the de-icing device 1. The unit 60 is configured to adapt the quantity of liquid sprayed as a function of the temperature outside the vehicle measured by the sensor 60 so that:
when the outside temperature is equal to T1, a quantity Q1 of liquid is ejected via the openings during each elementary movement of the blades,
when the outside temperature is equal to T2, with T2<T1, a quantity Q2 of liquid is ejected via these openings during each elementary movement, with Q2>Q1.

If FIG. 4a were to represent a de-icing cycle in very cold weather, for example at a temperature T2 of −20° C., the unit 60 could be configured to execute the de-icing cycle of FIG. 4b or 4c when the temperature is less cold, and is for example T1=0° C.

The essential difference between the de-icing cycle of FIG. 4b and that of FIG. 4a concerns the amplitude (LI) of the pulses of the control signal of the pump. Although the maximum value of the amplitude of the pulses of the control signal of the motor is maintained at 100%, as in the preceding cycle of FIG. 4a, i.e. the speed of sweeping the windscreen is unchanged, the maximum value of the amplitude of the pulses of the control signal of the pump is reduced to 75% (as against 100% in the cycle of FIG. 4a), which is reflected in a quantity of liquid sprayed by the pump that is lower in the FIG. 4b cycle than in that of FIG. 4a. Accordingly, for each elementary movement of the blades, the quantity of liquid sprayed will be lower at T1=0° C. than it is at T2=−20° C. The quantity of liquid used to optimize the de-icing of the vehicle without leading to over consumption of the de-icing liquid therefore depends on the outside temperature.

The essential difference between the FIG. 4c de-icing cycle and that of FIG. 4a concerns the width (Θ) of the pulses of the control signal of the pump. Although the duration for which the maximum amplitude of the pulses of the control signal of the motor is maintained is identical to that in the cycle of FIG. 4a, the duration for which the maximum amplitude of the pulses of the control signal of the pump is maintained is significantly reduced, which is reflected by a quantity of liquid sprayed by the pump that is lower in the FIG. 4c cycle than in that of FIG. 4a. Accordingly, for each elementary movement of the blades, the quantity of liquid sprayed will be lower at T1=0° C. than it is at T2=−20° C.

The electronic unit 60 may be configured to execute the cycle of FIG. 4b or 4c, on the one hand, at the temperature T1, which could be considered as a standard or default de-icing cycle, in cold weather, as well as to execute the cycle of FIG. 4a, on the other hand, at the temperature T2, which could be considered as a de-icing cycle in very cold weather.

In the aforementioned instances where the temperatures T1 and T2 are respectively 0° C. and −20° C., the quantities of liquid sprayed may be respectively Q1 and Q2. Q2=k.Q1, with k a coefficient that is preferably equal to 2 in this particular case.

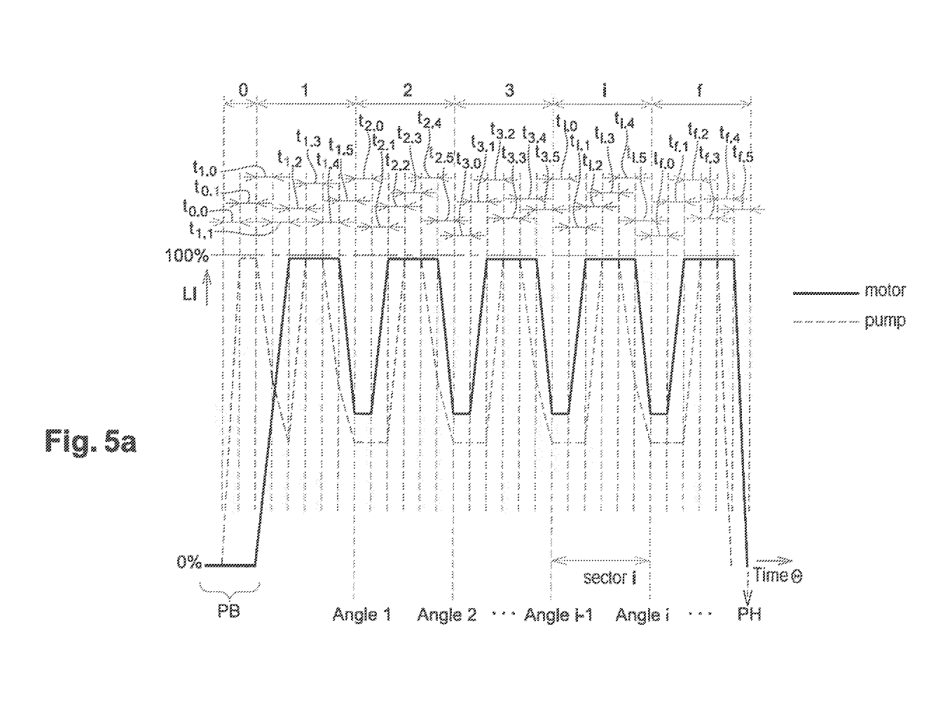

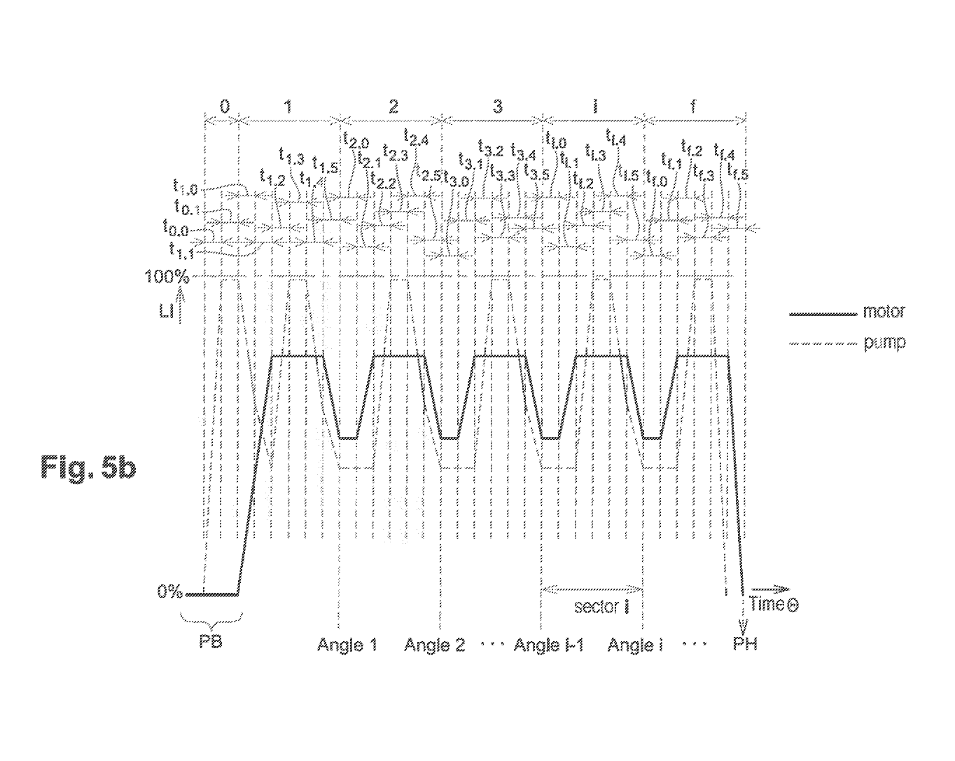

FIGS. 5a and 5b represent a variant embodiment of the invention, the cycle of FIG. 5a being identical to that of FIG. 4a.

Were FIG. 5a to represent a standard de-icing cycle in cold weather, for example at a temperature T1 of 0° C., the unit 60 could be configured to execute the FIG. 5b de-icing cycle when the temperature is colder, and is for example T2=−20° C.

The essential difference between the FIG. 5b de-icing cycle and that of FIG. 5a concerns the amplitudes (LI) of the pulses of the control signals of the pump and of the motor. The maximum value of the amplitude of the pulses of the control signal of the motor is reduced to 75% (as against 100% in the FIG. 5a cycle), which means that the speed of sweeping the windscreen is lower in the FIG. 5b cycle. The maximum value of the amplitude of the pulses of the control signal of the pump is maintained at 100%, which means that the quantity of liquid sprayed per unit time is the some as in the FIG. 5a cycle. Accordingly, as the blades move more slowly, they take longer to cover a given angular sector and the quantity of liquid sprayed over this time lapse is greater than sprayed in the time lapse necessary for the blades to travel over the same angular sector in the case of the FIG. 5a cycle. The quantity of liquid sprayed will be greater at T2=−20° C. than it is at T1=0° C. The quantity of liquid used to optimize the de-icing of the vehicle without leading to overconsumption of the de-icing liquid therefore depends on the outside temperature.

In the aforementioned instance in which the temperatures T1 and T2 are 0° C. and −20° C., respectively, the speeds of the blades may be V1 and V2, respectively. V1=k.V2, with k a coefficient that is preferably equal to 2 in this particular case.

Alternatively, the unit 60 is configured to maintain the quantity Q of liquid sprayed constant whatever the outside temperature so that when the outside temperature is equal to T1 and said liquid has a viscosity W1 the quantity Q of liquid is ejected via the openings and when the outside temperature is equal to T2, with T2<T1, and the liquid has a viscosity W2, with W2>W1, the same quantity Q of liquid is ejected via the openings.

Were FIG. 4a to present a de-icing cycle in very cold weather, for example at a temperature T2 of −20° C., the unit 60 could be configured to execute the FIG. 4b or 4c de-icing cycle when the temperature is less cold, and is for example T1=0° C.

Despite the pulse amplitude difference explained above between the FIG. 4b de-icing cycle and that of FIG. 4a, the quantity of liquid sprayed by the pump is identical for each angular sector in both cycles because of the viscosity difference of the liquid at the two temperatures concerned.

Similarly, despite the pulse width difference explained above between the FIG. 4c de-icing cycle and that of FIG. 4a, the quantity of liquid sprayed by the pump is identical for each angular sector in the two cycles because of the viscosity difference of the liquid at the two temperatures concerned.

In the aforementioned instances where the temperatures T1 and T2 are respectively 0° C. and −20° C., the quantities of liquid sprayed are identical and the activation times (pulse widths) of the pump are respectively t1 and t2. t2=k.t1, with k a coefficient that is preferably equal to 2 in this particular case.

FIGS. 5a and 5b represent a variant embodiment of the invention, the FIG. 5a cycle being identical to that of FIG. 4a.

In the aforementioned variant, and were FIG. 5a to represent a standard de-icing cycle in cold weather, for example at a temperature T1 of 0° C., the unit 60 could be configured to execute the FIG. 5b de-icing cycle when the temperature is colder, and is for example T2=−20° C.

Despite the pulse amplitude difference explained above between the FIG. 5b de-icing cycle and that of FIG. 5a, the quantity of liquid sprayed by the pump is identical for each angular sector in the two cycles because of the viscosity difference of the liquid at the two temperatures concerned.

In the aforementioned instances where the temperatures T1 and T2 are 0° C. and −20° C., respectively, the quantities of liquid sprayed are identical and the drive speeds of the blade are respectively V1 and V2. V1=k.V2, with K a coefficient that is preferably equal to 2 in this particular case.

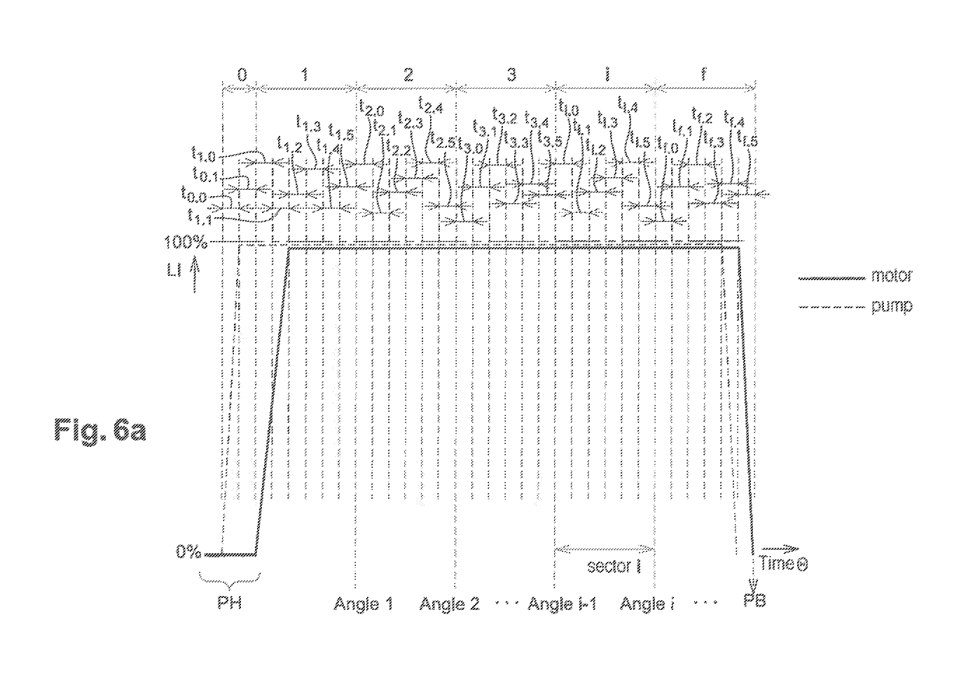

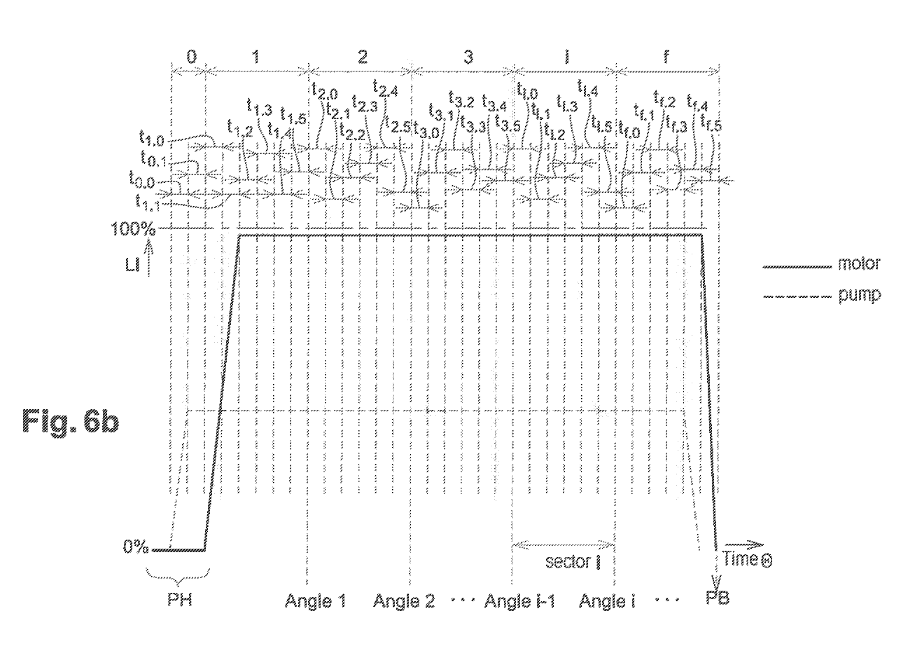

FIG. 6a is a graph that represents a de-icing cycle during a phase of a blade descending the windscreen. It is seen that the rotation of the blade between its high position PH and its low position PB is produced by a single movement.

In the rest position of the blades, at the beginning of the starting cycle, the blades are immobile in their top position, the drive motor and the feed pump being stopped because a pulse amplitude transmitted to their control system is equal to zero. During a time t0.0, when the drive motor 40 is maintained stopped, the pulse amplitude of the control of the feed pump 22 is progressively changed to 100%, this duration t0.0 corresponding to the maximum rate of increase of the pulse amplitude between 0 and 100%. This 100% pulse amplitude is maintained substantially throughout the duration of the descent. At the end of a time t0.1 the drive motor 40 is started by progressively increasing the pulse amplitude of its control signal from 0 to 100%. Then, from t1.1, the pulse amplitude of its control signal is maintained at 100% substantially throughout the duration of the descent of the blade or blades.

Were FIG. 6a to represent a de-icing cycle in very cold weather, for example at a temperature T2 of −20° C., the unit 60 could be configured to execute the FIG. 6b de-icing cycle when the temperature is less cold, and is for example T1=0° C.

The essential difference between the FIG. 6b de-icing cycle and that of FIG. 6a concerns the amplitude (LI) of the pulses of the control signal of the pump. Although the maximum value of the amplitude of the pulses of the control signal of the motor is maintained at 100%, as in the preceding cycle of FIG. 6a, i.e. the speed of sweeping the windscreen is unchanged, the maximum value of the amplitude of the pulses of the control signal of the pump is reduced to 75% (as against 100% in the FIG. 6a cycle), which is reflected in a quantity of liquid sprayed by the pump that is lower in the FIG. 6b cycle than in that of FIG. 6a. Accordingly, during the decent of the blades, the quantity of liquid sprayed will be lower at T1=0° C. than it is at T2=−20° C. The quantity of liquid used to optimise the de-icing of the vehicle without leading to overconsumption of the de-icing liquid therefore depends on the outside temperature.

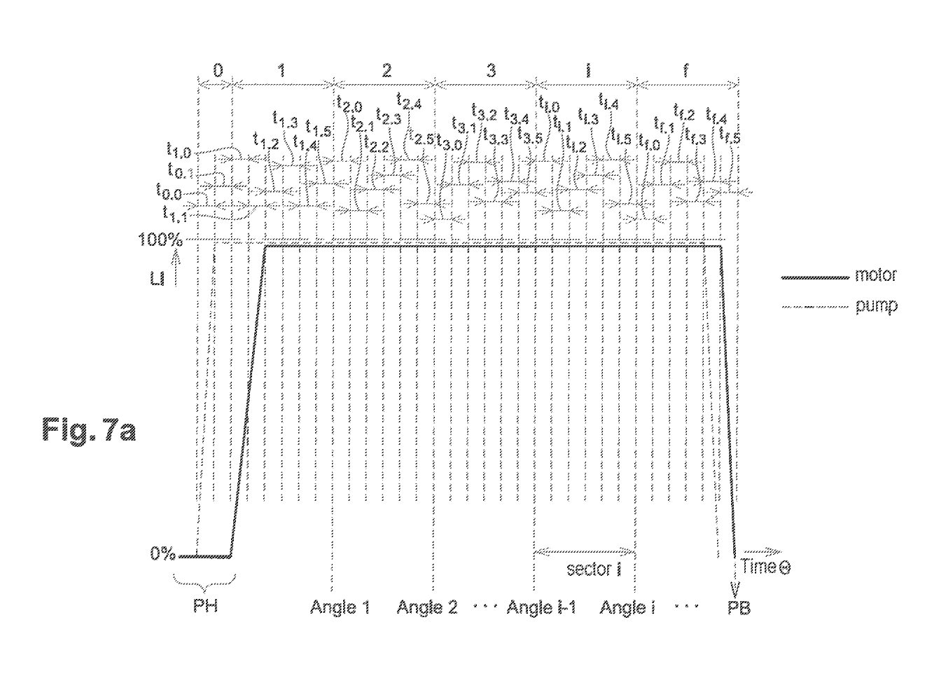

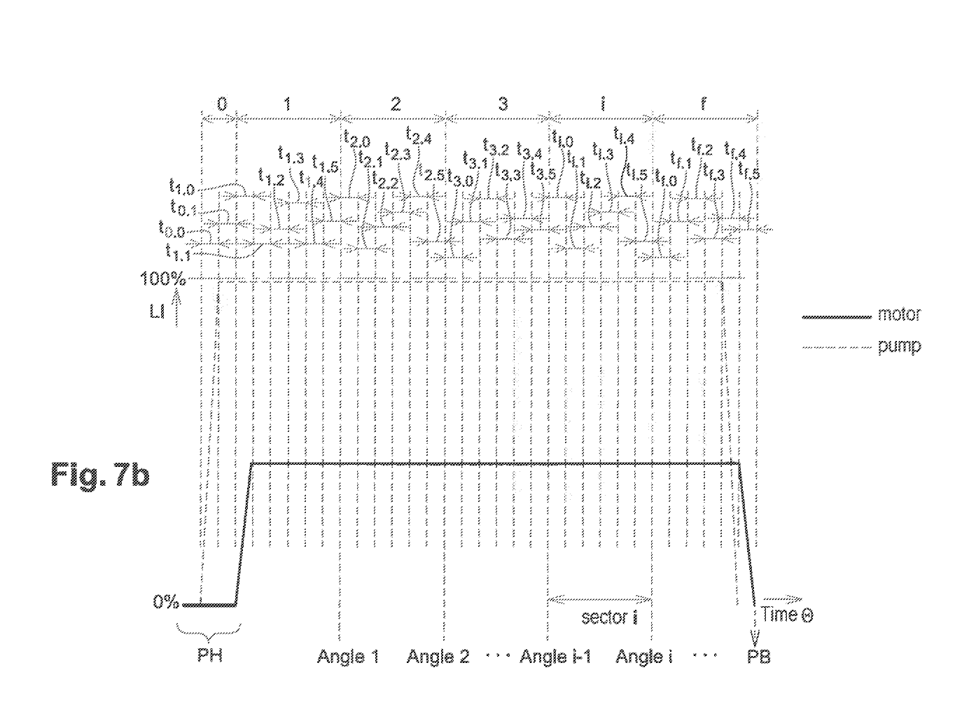

FIGS. 7e and 7b represent a variant embodiment of the invention, the FIG. 7a cycle being identical to that of FIG. 6a.

Were FIG. 7a to represent a standard de-icing cycle in cold weather, for example at a temperature T1 of 0° C., the unit 60 could be configured to execute the FIG. 7b de-icing cycle when the temperature is colder, and is for example T2=−20° C.

The essential difference between the FIG. 7b de-icing cycle and that of FIG. 7a concerns the amplitudes (LI) of the pulses of the control signals of the motor. The maximum value of the pulse amplitude of the control signal of the motor is reduced to 75% (as against 100% in the FIG. 5a cycle), which means that the speed of sweeping of the windscreen is lower in the FIG. 7b cycle. The maximum value of the pulse amplitude of the control signal of the pump is maintained at 100%, which means that the quantity of liquid sprayed per unit time is the same as in the FIG. 7a cycle. Therefore, as the blades move less quickly, they take longer to descend over the windscreen and the quantity of liquid sprayed over this time lapse is greater than that sprayed in the time lapse necessary for the blades to effect the descent in the case of the FIG. 7a cycle. The quantity of liquid sprayed will be greater at T2=−20° C. than it is at T1=0° C. The quantity of liquid used to optimize the de-icing of the vehicle without leading to overconsumption of the de-icing liquid therefore depends on the outside temperature.

In the aforementioned instances where the temperatures T1 and T2 are 0° C. and −20° C., respectively, the speeds of the blades may be V1 and V2, respectively. V1=k.V2, with k a coefficient that is preferably equal to 2 in this particular case.

The de-icing cycles described above are preferably executed with the vehicle stationary in order not to interfere with the driving of the vehicle.

1. A method for de-icing a vehicle window, said vehicle being equipped with a de-icing device comprising:
at least one tank containing a de-icing liquid;
a tube system connecting said at least one tank to openings through which said liquid is sprayed onto said window;
a pump intended to cause said liquid to circulate in the tube system until it is ejected via said openings; and
at least one wiper blade able to move on said window between a low position and a high position;
a drive motor for rotation of said at least one blade;
a sensor of the temperature outside the vehicle; and
an electronic unit for controlling said motor and actuating said pump, the method comprising a step 1 of:
ejecting the liquid via said openings and adapting the quantity of liquid sprayed as a function of said outside temperature, so that:
when said outside temperature is equal to T1, a quantity Q1 of liquid is ejected via said openings, and
when the outside temperature is equal to T2, with T2<T1, a quantity Q2 of liquid is ejected via said openings, with Q2>Q1,
or ejecting the liquid via said openings and maintaining the quantity Q of liquid sprayed constant whatever said outside temperature, so that:
when said outside temperature is equal to T1 and said liquid has a viscosity W1, the quantity Q of liquid is ejected via said openings, and
when the outside temperature is equal to T2, with T2<T1, and said liquid has a viscosity W2, with W2>W1, the same quantity Q of liquid is ejected via said openings.

2. The method according to claim 1, further comprising a step:
2) moving said at least one blade from said low position to said high position via a plurality of successive angular movements,
said steps 1) and 2) being notably performable simultaneously.

3. The method according to claim 2, wherein, said motor being configured so that the rotation speed V of said at least one blade and the quantity of liquid ejected by said pump are controlled by modulation of the pulse width and/or amplitude of their control signals, the step 2) is executed by a plurality of successive pulses of the control signal of said motor and the step 1) is executed by a plurality of successive pulses of the control signal of said pump.

4. The method according to claim 3, wherein the adaptation in the step 1) is executed by regulating the pulse width and/or amplitude of the control signal of said pump, so that:
when said outside temperature is equal to T1, the pulse width Θ1 and/or the pulse amplitude LI1 of said signal is/are applied to said pump,
when the outside temperature is equal to T2, the pulse width Θ2 and/or the pulse amplitude LI2 of said signal is/are applied to said pump, with Θ2>Θ1 and LI2>LI1.

5. The method according to claim 4, wherein the adaptation in the step 1) is executed by regulating the rotation speed V of said at least one blade, so that:
when said outside temperature is equal to T1, a speed V1 is applied to said at least one blade,
when the outside temperature is equal to T2, a speed V2 is applied to said at least one blade, with V2<V1.

6. The method according to claim 5, wherein T1 is between −5° C. and +5° C. inclusive.

7. The method according to claim 6, characterized in that T2 is between −10° C. and −30° C. inclusive.

8. The method according to claim 7, wherein Θ2=k.Θ1, with k a coefficient.

9. the method according to claim 7, wherein V1=k.V2, with k a coefficient.

10. The method according to claim 8, wherein k is between 1.5 and 3 inclusive.

11. The method according to claim 1, wherein the steps 1) and 2) are executed when the vehicle is stopped and the speed of the vehicle is zero.

12. The method according to claim 3, wherein the steps 1) and 2) are followed by steps:
moving said at least one blade from said high position to said low position, by means of a single angular movement, and
ejecting the liquid via said openings during said movement and adapting the quantity Q of liquid sprayed as a function of said outside temperature, so that:
when said outside temperature is equal to T1, a quantity Q1 of liquid is ejected via said openings during said movement,
when the outside temperature is equal to T2, with T2<T1, a quantity Q2 of liquid is ejected via said openings during said movement, with Q2>Q1.

13. The method in accordance with claim 12, wherein, during the steps 3) and 4), said pump is controlled by a pulse of its control signal of predetermined width and amplitude.

14. The method according to claim 12, wherein the adaptation in the step 4) is executed by regulating the rotation speed V of said at least one blade, so that:
when said outside temperature is equal to T1, a speed V1 is applied to said at least one blade,
when the outside temperature is equal to T2, a speed V2 is applied to said at least one blade, with V2<V1.

15. A device for de-icing a vehicle window, comprising:
at least one tank containing a de-icing liquid;
a tube system connecting said at least one tank to openings through which said liquid is sprayed onto said window;
a pump intended to cause said liquid to circulate in the tube system until it is ejected via said openings;
at least one wiper blade able to move on said window between a low position and a high position,
a drive motor for rotation of said at least one blade;
a sensor of the temperature T outside the vehicle; and
an electronic unit for controlling said motor and actuating said pump,
wherein said electronic unit is configured to execute the steps of the method according to claim 1.
